(19) United States
(12) Patent Application Publication
(10) Pub. No.: US 2010/0055378 A1
(43) Pub. Date: Mar. 4, 2010

(54) ENCAPSULATED IONIC POLYMER-METAL COMPOSITE DEVICE

(75) Inventors: Yong Hyup Kim, Seoul (KR); Seong Jun Kim, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SNU R&DB FOUNDATION, Seoul (KR)

(21) Appl. No.: 12/198,741

(22) Filed: Aug. 26, 2008

(51) Int. Cl. B32B 3/02

(52) U.S. Cl. 428/68

(57) ABSTRACT

Ionic polymer-metal composite (IPMC) devices are provided. In one embodiment, an ionic polymer-metal composite (IPMC) device includes an ionic polymer film, first and second electrodes, first and second external electrodes disposed on the electrodes, first and second bonding members electrically connecting and physically bonding the electrodes to the external electrodes, and an encapsulation layer encapsulating the ionic polymer film, the first electrode and the second electrode to prevent exposure to the outside ambient.

### TECHNICAL FIELD

The described technology relates generally to sensors and actuators and, more particularly, to encapsulated ionic polymer-metal composite devices.

### BACKGROUND

An ionic polymer-metal composite (IPMC) was first proposed by the Oguro group in 1992, and is one of the most promising electroactive polymers (EAPs). Typically, an IPMC device may include metal electrodes, a composite of a fluorine-substituted ionic polymer film, for example, a Nafion film (i.e., a perfluorosulfonate ionomer manufactured by DuPont Co.), and platinum electrodes disposed on both surfaces of the Nafion film. Applying an electric field may cause the IPMC device to undergo bending deformation, and the IPMC device may be used as an actuator. The mechanical deformation may relate to an electro-osmosis phenomenon that may be generated in the IPMC device. For example, a voltage applied between the electrodes may cause cations in the IPMC device to move toward a cathode together with water molecules, and the volume of the IPMC device of the cathode side may expand so the IPMC device may bend toward an anode. If the IPMC device mechanically undergoes bending deformation, an irregular ion concentration in the IPMC device may cause a voltage difference to be generated between the electrodes, and the IPMC device may be used as a sensor.

Since the actuation mechanism of the IPMC device as the actuator may depend on an electro-osmosis phenomenon, in which cations may move together with water molecules, an ionic polymer film of the IPMC device may maintain a predetermined amount of moisture. During the actuation of the IPMC device, the moisture in the ionic polymer film may gradually be evaporated, which may result in deteriorated performance of the actuator. In order to prevent moisture in the IPMC device from evaporating, the IPMC may be encapsulated. This technique is disclosed by J. Barramba, et al., Sensors and Actuators A 140, pp. 232-238, 2007. In the paper, it is disclosed that a copper wire may be welded to an electrode of the IPMC device, and the whole IPMC device may be encapsulated using a silicon polymer.

### BRIEF DESCRIPTION OF THE DRAWINGS

FIG. 1(a) is a cross-sectional view of an illustrative embodiment of an encapsulated ionic polymer-metal composite (IPMC) device.

FIG. 1(b) is an exploded perspective view of an illustrative embodiment of an IPMC device.

FIG. 2(a) is a perspective view of an illustrative embodiment of a bonding member of an encapsulated IPMC device.

FIG. 2(b) is a cross-sectional view of an illustrative embodiment of a bonding member of an encapsulated IPMC device.

FIG. 3(a) is a perspective view of an illustrative embodiment of a bonding member of an encapsulated IPMC device.

FIG. 3(b) is a cross-sectional view of an illustrative embodiment of a bonding member of an encapsulated IPMC device.

FIG. 4(a) is a perspective view of an illustrative embodiment of a bonding member of an encapsulated IPMC device.

FIG. 4(b) is a cross-sectional view of an illustrative embodiment of a bonding member of an encapsulated IPMC device.

FIG. 5(a) is a perspective view of an illustrative embodiment of a bonding member of an encapsulated IPMC device.

FIG. 5(b) is a cross-sectional view of an illustrative embodiment of a bonding member of an encapsulated IPMC device.

FIG. 6 is a cross-sectional view of an illustrative embodiment of a system including an encapsulated IPMC device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes made be made, without departing from the spirit or scope of the subject matter presented here. It will be readily understood that the components of the present disclosure, as generally described herein, and illustrated in the Figures, can be arranged, substituted, combined, and designed in a wide variety of different configurations, all of which are explicitly contemplated and make part of this disclosure.

It will also be understood that when an element or layer is referred to as being “on” or “connected to” another element or layer, the element or layer may be directly on or connected to the other element or layer or one or more intervening elements or layers may be present.

In one embodiment, an ionic polymer-metal composite (IPMC) device may include an ionic polymer film, a first electrode disposed on a first surface of the ionic polymer film, a second electrode disposed on a second surface of the ionic polymer film, which is opposite the first surface, a first external electrode disposed on the first electrode, a second external electrode disposed opposite to the first external electrode and on the second electrode, a first bonding member electrically connecting and physically bonding the first electrode to the first external electrode, a second bonding member electrically connecting and physically bonding the second electrode to the second external electrode, and a coating layer encapsulating the ionic polymer film, the first electrode and the second electrode.

In another embodiment, a system may include an IPMC device and a power supply. The IPMC device may be encapsulated by a coating layer, and may have a first external electrode and a second external electrode, which may be at least partially exposed from the coating layer. The IPMC device may have a first bonding member and a second bonding member that may electrically and mechanically connect a first electrode and a second electrode, which may be disposed on both opposite surfaces of an ionic polymer film, to the first external electrode and the second external electrode. The power supply may include an electrode connection part that may be attachable to the first external electrode and the second external electrode, and a power source that may apply a voltage to the first external electrode and the second external electrode.

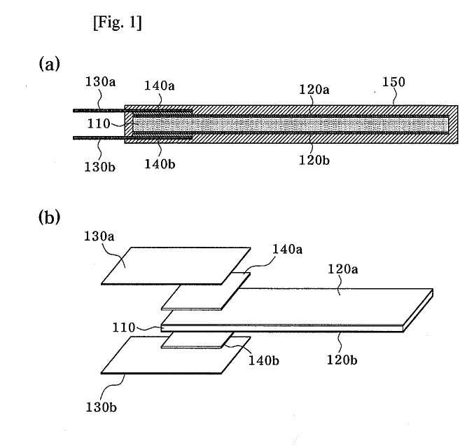

FIG. 1(a) is a cross-sectional view of an illustrative embodiment of an encapsulated ionic polymer-metal composite (IPMC) device encapsulated by a coating layer. FIG. 1(b) is an exploded perspective view of an illustrative embodiment of an IPMC device before an encapsulation may be performed. As depicted, the IPMC device may include an ionic polymer film 110, a first electrode 120a, a second electrode 120b, a first external electrode 130a, a second external electrode 130b, a first bonding member 140a, a second bonding member 140b, and a coating layer 150.

The ionic polymer film 110 may be made of any suitable polymer material with ion exchange capacity, which may be, for example, a fluorocarbon-based polymer having an ionic group or a styrene/divinylbenzene polymer having an ionic group. A side group attached to a main chain of the polymer may have an ionic end group such as SO₃⁻ or COO⁻. A polymer backbone may determine mechanical power, and the hydrophilic side group may provide ionic groups interacting with water and pathway for appropriate ions. Examples of the fluorocarbon-based polymer may include a perfluorosulfonic acid polymer such as Nafion (manufactured by DuPont Co.) or a perfluorocarboxylic acid polymer such as Flemion (manufactured by Asahi Glass Co., Ltd.). As described above, the ionic polymer film 110 may be bent when a voltage is applied between the first electrode 120a and the second electrode 120b.

The first electrode 120a may be disposed on a first surface of the ionic polymer film 110. The second electrode 120b may be disposed on a second surface of the ionic polymer film 110. The second surface is opposite the first surface of the ionic polymer film 110. The first electrode 120a and the second electrode 120b may be formed of, for example, a metal such as Au, Ag, Cu, Fe, Co, Ni, Ta, W, Ti, Pt, Pd, TiN, etc., or an alloy thereof. These materials may be used alone or in combinations thereof to form the first electrode 120a and the second electrode 120b.

The first external electrode 130a may be disposed on the first electrode 120a, and the second external electrode 130b may be disposed opposite to the first external electrode 130a and on the second electrode 120b. The first external electrode 130a and the second external electrode 130b may be electrically connected to the first electrode 120a and the second electrode 120b, respectively, and may be at least partially exposed from the coating layer 150. The coating layer 150 may encapsulate the ionic polymer film 110 together with the first electrode 120a and the second electrode 120b. The first electrode 120a and the second electrode 120b may extend outward from the coating layer 150 by the first external electrode 130a and the second external electrode 130b, respectively. The first external electrode 130a and the second external electrode 130b may be formed of, for example, a metal such as Au, Ag, Cu, Fe, Co, Ni, Ta, W, Ti, Pt, Pd, TiN, etc., or an alloy thereof. There materials may be used alone or in combinations thereof to form the first external electrode 130a and the second external electrode 130b.

The first bonding member 140a may be disposed between the first electrode 120a and the first external electrode 130a to electrically connect and physically bond the first electrode 120a to the first external electrode 130a. The second bonding member 140b may be disposed between the second electrode 120b and the second external electrode 130b to electrically connect and physically bond the second electrode 120b to the second external electrode 130b.

In one embodiment, at least one of the first bonding member 140a and the second bonding member 140b may include a conductive layer and an adhesive layer for electrical connection and bonding. The conductive layer may be formed of, for example, a metal such as Au, Ag, Cu, Fe, Co, Ni, Ta, W, Ti, Pt, Pd, TiN, etc, or an alloy thereof. These materials may be used alone or in combinations thereof to form the conductive layer. In various embodiments, the adhesive layer may be formed of a polymer material. In other embodiments, the adhesive layer may be formed of an insulating adhesive such as, but not limited to, an epoxy adhesive, an acrylic adhesive or a silicon adhesive. In other embodiments, the adhesive layer may be formed of an electroconductive adhesive. The conductive layer and the adhesive layer used for the first bonding member 140a and the second bonding member 140b may be in the shape of a film having an area large enough to be strongly bonded to the first and the second electrodes 120a and 120b and the first and the second external electrodes 130a and 130b.

In another embodiment, at least one of the first bonding member 140a and the second bonding member 140b may be formed of a conductive adhesive. In still another embodiment, at least one of the first bonding member 140a and the second bonding member 140b may be formed of an intrinsically conductive polymer (ICP).

The conductive adhesive may be a compound, in which a filler having conductivity, a solvent, a curing agent, an additive agent, etc. may be included in a polymer matrix such as a thermoplastic or thermosetting resin. The thermoplastic resin may be, for example, a polyester resin, an acrylic resin, a polyimide resin or a polysulfone resin. The thermosetting resin may be, for example, an epoxy resin, a phenolic resin, or a melamine resin. The filler may include, for example, silver, copper, gold, palladium, a silver-palladium alloy, carbon, or nickel. For example, the conductive adhesive may be a compound in which an epoxy resin is blended with silver particles as fillers. In some embodiments, when applied to the first bonding member 140a or the second bonding member 140b, conductive fillers dispersed in the conductive adhesive may be in contact with each other in the process of hardening or solidifying of the conductive adhesive, so that conductivity of the conductive adhesive may be obtained.

The coating layer 150 may encapsulate the ionic polymer film 110, the first electrode 120a and the second electrode 120b and may substantially or completely prevent exposure of the ionic polymer film 110, the first electrode 120a and the second electrode 120b to the outside ambient. As a result, the coating layer 150 may substantially prevent moisture from being evaporated from the ionic polymer film 110. In this case, the first and the second external electrodes 130a and 130b may extend from the first and the second electrodes 120a and 120b through the first and the second bonding members 140a and 140b. The first and the second external electrodes 130a and 130b may be at least partially exposed from the coating layer 150, and thus may be supplied with power from an external power source. The coating layer 150 may be formed of any suitable material having insulation characteristics and suitable stiffness. For example, silicon rubber (e.g., PDMS) or parylene may be used as the coating layer 150. The coating layer 150 may be formed by, for example, a dip coating method or a chemical vapor deposition method.

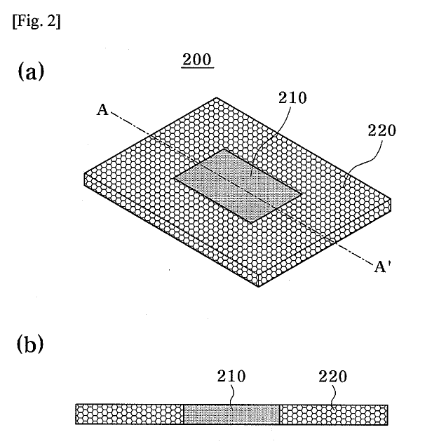

FIGS. 2 to 5 are perspective views (a) and cross-sectional views (b) of illustrative embodiments of bonding members of encapsulated IPMC devices. The cross-sectional views are taken along line A-A′ of the perspective views, respectively. A bonding member disclosed in each embodiment may, for example, correspond to the first bonding member 140a or the second bonding member 140b of FIG. 1.

As illustrated in FIG. 2, a bonding member 200 may include a conductive layer 210 and an adhesive layer 220. The conductive layer 210 may be a metal film. The conductive layer 210 may be disposed between the first or the second electrode 120a or 120b of FIG. 1 and the first or the second external electrode 130a or 130b of FIG. 1 to be in electrical contact with the first or the second electrode 120a or 120b and the first or the second external electrode 130a or 130b. The adhesive layer 220 may, for example, be a polymer film. The adhesive layer 220 may be disposed on the same plane with the conductive layer 210 to surround the conductive layer 210. The adhesive layer 220 may be disposed between the first or the second electrode 120a or 120b of FIG. 1 and the first or the second external electrode 130a or 130b of FIG. 1 to be in contact with the first or the second electrode 120a or 120b and the first or the second external electrode 130a or 130b. The adhesive layer 220 may, for example, be formed of an insulating adhesive. Alternatively, the adhesive layer 220 may be formed of a conductive adhesive.

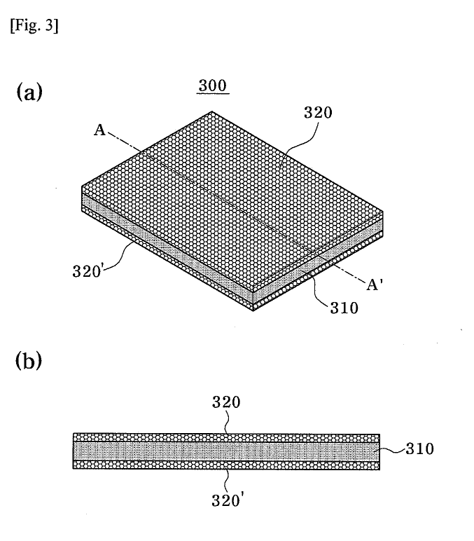

As illustrated in FIG. 3, a bonding member 300 may include a conductive layer 310 and adhesive layers 320 and 320′. The conductive layer 310 may be in the shape of a metal film, and both opposite sides of the conductive layer 310 may be coated with the adhesive layers 320 and 320′, so that the bonding member 300 may be in the shape of a conductive tape. The adhesive layers 320 and 320′ may, for example, be made of a conductive adhesive. The bonding member 300 having the shape of the conductive tape may provide convenience of use. That is, the bonding member 300 may be cut in a desired shape and may be attached to a desired position.

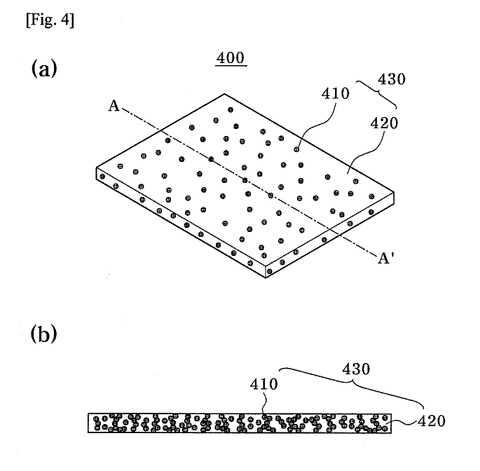

As illustrated in FIG. 4, a bonding member 400 may be made of a conductive adhesive 430. The conductive adhesive 430 may be a mixture of a polymer matrix 420 and conductive fillers 410. When applied to the bonding member 400, the conductive fillers 410 dispersed in the conductive adhesive 430 may be in contact with each other in the process of hardening or solidifying of the conductive adhesive 430, so that conductivity of the conductive adhesive 430 may be obtained.

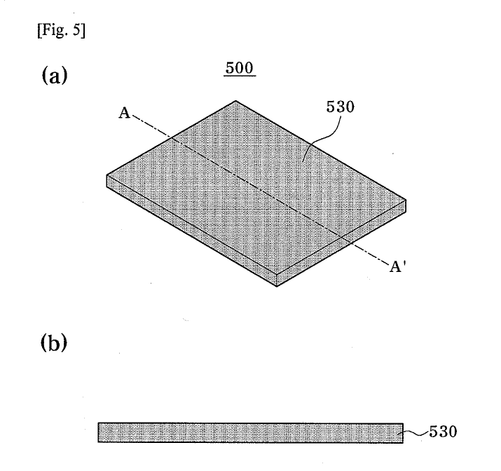

As illustrated in FIG. 5, a bonding member 500 may be made of an intrinsically conductive polymer (ICP) 530. For example, the ICP 530 may be polyaniline.

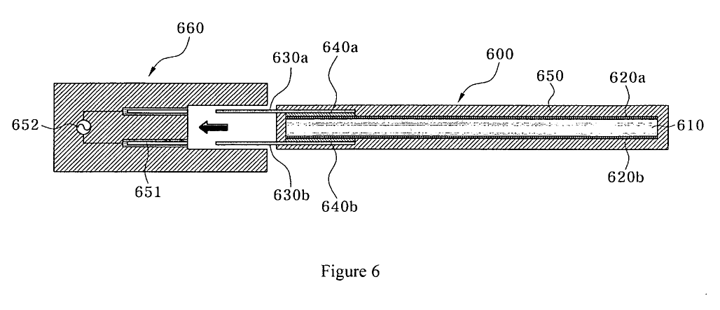

FIG. 6 is a cross-sectional view of an illustrative embodiment of a system including an encapsulated IPMC device. As illustrated, the system may include an encapsulated IPMC device 600 and a power supply 660. The encapsulated IPMC device 600 may be encapsulated by a coating layer 650, and may include a first external electrode 630a and a second external electrode 630b, which may be at least partially exposed from the coating layer 650. The encapsulated IPMC device 600 may include a first bonding member 640a and a second bonding member 640b. The first bonding member 640a and the second bonding member 640b may electrically and mechanically connect a first electrode 620a and a second electrode 620b, which may be disposed on both opposite surfaces of an ionic polymer film 610, to the first external electrode 630a and the second external electrode 630b, respectively. The power supply 660 may include an electrode connection part 651 and a power source 652. The electrode connection part 651 may be attachable to the first external electrode 630a and the second external electrode 630b. The power source 652 may apply a voltage to the first external electrode 630a and the second external electrode 630b.

The encapsulated IPMC device 600 may include any of the aspects of the embodiments and examples as previously described, and a more detailed description thereof will be omitted for the sake of brevity.

As described above, the system of FIG. 6 may include the power supply 660 having the electrode connection part 651, and the encapsulated IPMC device 600 may be attached and detached as necessary.

According to some embodiments of the present disclosure, the encapsulated IPMC device may use a bonding member including a polymer material as an adhesive layer between an internal electrode and an external electrode. When using the bonding member as the adhesive layer, the external electrode and the internal electrode may be easily connected to each other without experiencing excessive heat which may cause thermal deformation of an ionic polymer in the encapsulated IPMC device. In addition, a bonding area of the present disclosure may be larger than that of the conventional welding, and the external electrode may not be easily separated from the encapsulated IPMC device during the repeated tension and compression processes of the encapsulated IPMC device during the actuation of the encapsulated IPMC device. Therefore, the encapsulated IPMC device described above may provide a reliable structure. The bonding member in the embodiments may offer the advantages of having low cost and manufacturing processes of the encapsulated IPMC device. Therefore, the encapsulated IPMC device may be manufactured in large quantities at low cost.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An ionic metal-polymer composite (IPMC) device, comprising:
an ionic polymer film;
a first electrode disposed on a first surface of the ionic polymer film;
a second electrode disposed on a second surface of the ionic polymer film, the second surface being opposite to the first surface;
a first external electrode disposed on the first electrode;
a second external electrode disposed opposite to the first external electrode and on the second electrode;
a first bonding member electrically connecting and physically bonding the first electrode to the first external electrode;
a second bonding member electrically connecting and physically bonding the second electrode to the second external electrode; and
a coating layer encapsulating the ionic polymer film, the first electrode, and the second electrode.

2. The IPMC device of claim 1, wherein at least one of the first bonding member and the second bonding member comprises a conductive layer and an adhesive layer.

3. The IPMC device of claim 2, wherein the conductive layer comprises at least one of a metal or a metal alloy.

4. The IPMC device of claim 2, wherein the adhesive layer comprises a polymer material.

5. The IPMC device of claim 2, wherein the conductive layer and the adhesive layer are disposed on the same plane.

6. The IPMC device of claim 5, wherein the adhesive layer comprises an insulating adhesive.

7. The IPMC device of claim 2, wherein the adhesive layer is coated on both opposite surfaces of the conductive layer.

8. The IPMC device of claim 7, wherein the adhesive layer comprises a conductive adhesive.

9. The IPMC device of claim 1, wherein at least one of the first bonding member and the second bonding member comprises a conductive adhesive.

10. The IPMC device of claim 1, wherein at least one of the first bonding member and the second bonding member comprises an intrinsically conductive polymer (ICP).

11. The IPMC device of claim 1, wherein the first external electrode and the second external electrode are at least partially exposed from the coating layer.

12. The IPMC device of claim 1, wherein the coating layer comprises at least one of silicon rubber or parylene.

13. The IPMC device of claim 1, wherein the coating layer is formed by a dip coating method or a chemical vapor deposition method.

14. A system, comprising:
a ionic metal-polymer composite (IPMC) device encapsulated by a coating layer, and having a first external electrode and a second external electrode, the first external electrode and the second external electrode at least partially exposed from the coating layer; and
a power supply including an electrode connection part configured to be attachable to the first external electrode and the second external electrode, and a power source configured to apply a voltage to the first external electrode and the second external electrode,
wherein the IPMC device includes a first bonding member and a second bonding member that electrically and mechanically connect a first electrode and a second electrode, which are disposed on both opposite surfaces of an ionic polymer film, to the first external electrode and the second external electrode, respectively.

15. The system of claim 14, wherein at least one of the first bonding member and the second bonding member comprises a conductive layer and an adhesive layer.

16. The system of claim 14, wherein at least one of the first bonding member and the second bonding member comprises a conductive adhesive.

17. The system of claim 14, wherein at least one of the first bonding member and the second bonding member comprises an intrinsically conductive polymer (ICP).
